(19) United States
(12) Patent Application Publication
(10) Pub. No.: US 2017/0153329 A1
(43) Pub. Date: Jun. 1, 2017

(54) OBJECT DETECTION APPARATUS

(71) Applicant: DENSO CORPORATION, Kariya-city (JP)

(72) Inventor: Kimio Kodama, Kariya-city (JP)

(21) Appl. No.: 15/239,587

(22) Filed: Aug. 17, 2016

(30) Foreign Application Priority Data
Aug. 19, 2015 (JP) 2015-162137

(51) Int. Cl. G01S 17/93; G08G 1/16; G01S 7/481; B60R 1/12

(52) U.S. Cl. CPC G01S 17/936; B60R 1/12; G08G 1/167; G01S 7/4814

(57) ABSTRACT

An object detection apparatus includes an irradiation section that transmits light, and a detection section that detects an object that has reflected light transmitted from the irradiation section, based on reflected light reflected from the object to which the light is transmitted from the irradiation section. The irradiation section transmits the light to a wheel region of an adjacent vehicle. The adjacent vehicle is assumed to be present in an adjacent lane adjacent to a lane in which an own vehicle runs. The wheel region is a predetermined region in which a wheel of the adjacent vehicle is assumed to be present.

### CROSS-REFERENCE TO RELATED APPLICATION

This application is based on and claims the benefit of priority from earlier Japanese Patent Application No. 2015-162137 filed Aug. 19, 2015, the description of which is incorporated herein by reference.

### BACKGROUND

Technical Field

The present invention relates to a technique for detecting an object.

Related Art

Conventionally, a technique is known in which laser light is transmitted to detect an object present in the lateral direction from an own vehicle. JP-A-2009-103482 discloses a technique in which part of the laser light transmitted ahead of an own vehicle is reflected laterally from the own vehicle by a reflecting mirror to detect an object present in the lateral direction from the own vehicle.

However, according to the technique disclosed in JP-A-2009-103482, if a vehicle present in the lateral direction from the own vehicle is black, the transmitted laser light is absorbed by the black vehicle body. Hence, the intensity of the reflected light lowers. Thereby, the black vehicle may not be detected.

### SUMMARY

An embodiment provides a technique for detecting a vehicle without depending on the color of the vehicle body.

As an aspect of the embodiment, an object detection apparatus includes an irradiation section that transmits light; and a detection section that detects an object that has reflected light transmitted from the irradiation section, based on reflected light reflected from the object to which the light is transmitted from the irradiation section. The irradiation section transmits the light to a wheel region of an adjacent vehicle, the adjacent vehicle being assumed to be present in an adjacent lane adjacent to a lane in which an own vehicle runs, the wheel region being a predetermined region in which a wheel of the adjacent vehicle is assumed to be present.

### BRIEF DESCRIPTION OF THE DRAWINGS

In the accompanying drawings:

FIG. 1 is a diagram illustrating schematic configurations of a driving assistance system and a radar unit according to embodiments;

FIG. 2 is a schematic diagram illustrating an example of an area to which laser light is transmitted;

FIG. 3 is a functional block diagram illustrating a configuration of a radar control section;

FIG. 4A is a diagram illustrating irradiation regions (first layer to third layer) of an experimental object in the horizontal direction;

FIG. 4B is a diagram illustrating a result of an experiment in which a black vehicle is an experimental object; and

FIG. 4C is a diagram illustrating a result of the experiment in which a white vehicle is an experimental object.

FIG. 5 is a diagram illustrating an adjacent vehicle;

FIG. 6A is a diagram illustrating an own vehicle and the adjacent vehicle viewed from behind the vehicles and in the travelling direction, and illustrating an example of an irradiation region of an irradiation section according to the first embodiment;

FIG. 6B is a diagram illustrating the own vehicle and the adjacent vehicle viewed from behind the vehicles and in the travelling direction, and illustrating an example of the irradiation region of the irradiation section according to a comparative example of the first embodiment;

FIG. 7 is a diagram illustrating an example of a result of the experiment in which when a threshold value is 0.1 or more, a reflected wave from an object is detected by a light receiving section at light receiving intensity higher than detection limit intensity;

FIGS. 8A and 8B are diagrams illustrating influence of reflection from a road surface in a received signal waveform;

FIG. 9 is a diagram illustrating the own vehicle and the adjacent vehicle viewed from behind the vehicles in the travelling direction, and illustrating an example of positions where the irradiation sections are provided according to a second embodiment; and

FIG. 10 is a diagram illustrating the own vehicle and the adjacent vehicle viewed from behind the vehicles in the travelling direction, and illustrating an example of positions where the irradiation sections are provided according to a first modification and a second modification of the second embodiment.

### DETAILED DESCRIPTION OF THE PREFERRED EMBODIMENTS

Hereinafter, embodiments are described with reference to the drawings.

### First Embodiment

[Overall configuration]

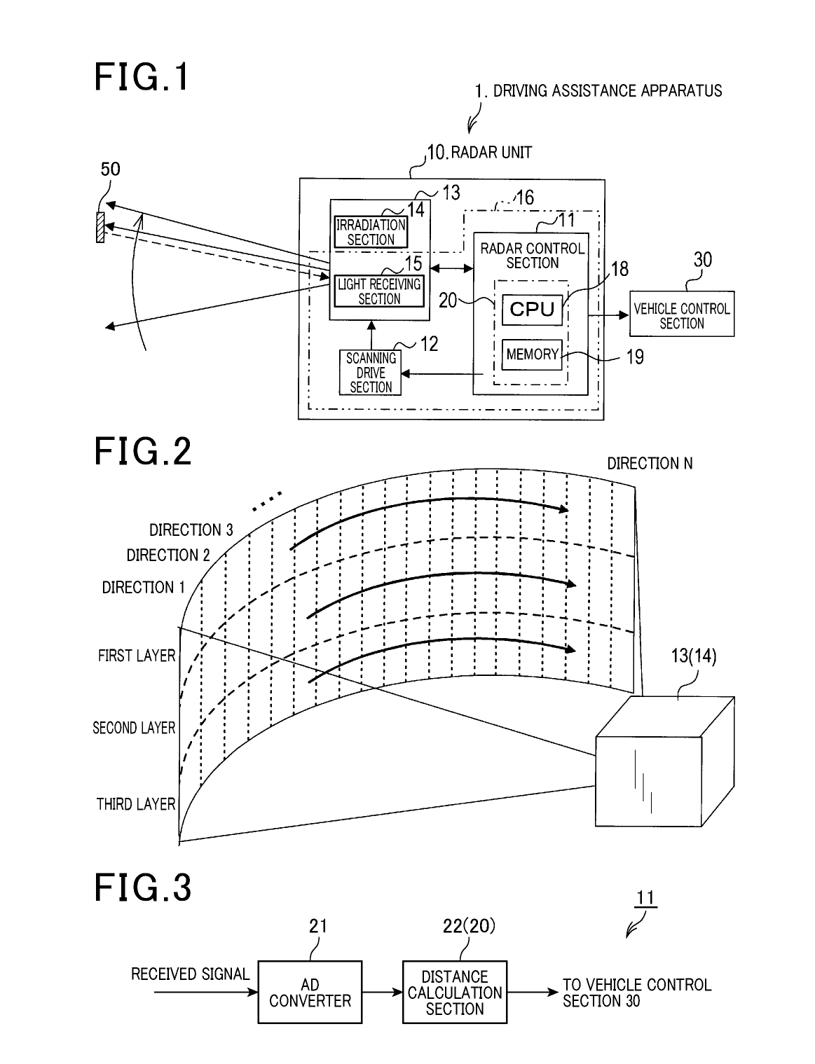

A driving assistance apparatus 1 is mounted in a vehicle (hereinafter, also referred to as “own vehicle”) such as a passenger car. The driving assistance apparatus 1 includes, as shown in FIG. 1, a radar unit 10 and a vehicle control section 30.

The radar unit 10 is provided, for example, to a right door mirror with respect to the traveling direction of the vehicle, and detects an object present in the right lateral direction from the own vehicle (refer to FIG. 5). Note that the radar unit 10 may be provided to a position where at least one of objects is present in the left direction and in the right direction from the own vehicle. The radar unit 10 may be provided not only to a door mirror but also at any position (height). Examples of the object include various things such as a vehicle, a pedestrian, and a building.

The radar unit 10 includes a radar control section 11, a scanning drive section 12, and an optical unit 13. The optical unit 13 includes an irradiation section 14 and a light receiving section 15. Hereinafter, in the radar unit 10, portions other than the irradiation section 14 are referred to as a detection section 16 depending on the description. The detection section 16 detects an object that has reflected light transmitted (emitted) from the irradiation section 14, based on the reflected light reflected from the object to which the light is transmitted from the irradiation section 14. As described above, the detection section 16 detects an object based on the reflected light, that is, based on, for example, a time period from the time when the irradiation section 14 transmits light to the time when the reflected light is received, or the intensity of the received reflected light. In addition, detecting an object means, for example, detecting a distance to an object and detecting presence or absence of an object.

Specifically, the radar control section 11 is configured as a known microcomputer including a CPU 18 and a memory 19 such as a ROM and a RAM. The CPU 18 performs various processes according to a program stored in the memory 19. In the processes, for example, a distance to an object, a speed of the object, and an acceleration of the object are detected based on an output from the optical unit 13. Note that the radar control section 11 may be configured by hardware such as a circuit.

The scanning drive section 12 includes an actuator such as a motor. The scanning drive section 12 is configured to receive a command from the radar control section 11 to direct the optical unit 13 in any one of the horizontal direction and the vertical direction. Note that every time when the scanning drive section 12 receives a scanning start signal from the radar control section 11, the scanning drive section 12 drives the optical unit 13 so as to perform one cycle of scanning by which reflected light can be obtained from all the areas to which laser light should be transmitted.

The optical unit 13 includes the irradiation section 14 and the light receiving section 15. The irradiation section 14 transmits light (referred to as laser light) in response to the command received from the radar control section 11. The light receiving section 15 receives reflected light (shown by a broken line in FIG. 1) generated in such a manner that laser light (shown by solid lines with arrows in FIG. 1) transmitted from the irradiation section 14 is reflected from an object 50.

Note that the scanning drive section 12 may have a configuration by which the radiation direction of laser light from the irradiation section 14 is changed so as to meet the direction in which the light receiving section 15 can receive the reflected light. For example, the scanning drive section 12 may be configured so as to drive, instead of the optical unit 13, a mirror that is included in the optical unit 13, the mirror reflecting the laser light and the reflected light in given directions.

In this case, a configuration may be employed by which the scanning drive section 12 rotates a mirror having a plurality of reflective surfaces to perform scanning with laser light in the horizontal direction, and sets angles of the reflective surfaces so as to be different from each other to perform scanning with laser light also in the vertical direction. Alternatively, a mechanism may be employed by which a mirror having one reflective surface is directed in given directions.

In addition, the scanning drive section 12 may be configured so as to change only the direction of the light receiving section 15. In this case, the irradiation section 14 may be configured so as to be capable of radiating laser light to part or the whole of the area which the light receiving section 15 scans without changing the direction of the irradiation section 14.

As described above, the radar unit 10 is configured as a laser radar. While the radar unit 10 scans a predetermined area around the own vehicle and in a given direction (in the present embodiment, in front of the own vehicle, that is, in the travelling direction of the own vehicle), and intermittently transmits laser light, which is light waves, the radar unit 10 receives reflected light generated from the light waves to detect an object present ahead of the own vehicle as detection points.

In the radar unit 10 of the present embodiment, the radar control section 11 uses the scanning drive section 12 as described above to scan a predetermined area with laser light transmitted from the optical unit 13. Specifically, as shown in FIG. 2, the radar control section 11 makes the optical unit 13 transmits laser light to the area from the top left corner to the top right corner and in the horizontal direction to the right intermittently and at regular intervals (regular angles), while changing the region to which the laser light is transmitted. When the laser light reaches the top right corner, the radar control section 11 makes the optical unit 13 transmit laser light again from an area lower than the top left corner at a predetermined angle and in the horizontal direction to the right, while changing the region to which the laser light is transmitted.

By repeating the above operation, the radar unit 10 transmits laser light serially to all the predetermined area. Then, the radar unit 10 calculates a position of an object (detection point) every time when the laser light is transmitted, based on the timing when the reflected light is received and the direction in which the laser light is transmitted.

To identify the direction in which laser light is transmitted, the whole area to which the laser light is transmitted is previously divided into areas, to which the laser light is transmitted, in a matrix state so as to be identified by numbers added to the respective areas. For example, as shown in FIG. 2, numbers are serially assigned from the left and in the horizontal direction. The numbers are referred to as direction numbers. In addition, numbers are serially assigned from the top and in the vertical direction. The numbers are referred to as layer numbers. Note that, in FIG. 2, three layers, the first layer to the third layer, are set in the vertical direction. However, the number of layers is not limited to three but may be optionally modified.

The vehicle control section 30 includes a known microcomputer including a CPU, a ROM, and a RAM, which are not shown. The vehicle control section 30 performs a process for controlling the behavior of the own vehicle, a process for making a notification for the driver, and the like, according to a program stored in the ROM or the like. For example, when the vehicle control section 30 receives a command for performing driving assistance in changing the behavior of the own vehicle (or prompting the driver to change the behavior) from the radar unit 10, the vehicle control section 30 outputs a control signal corresponding to the command to any of a display unit, an audio output unit, a brake unit, a steering unit, and the like.

As shown in FIG. 3, the radar control section 11 includes an AD converter 21 and a distance calculation section 22. The AD converter 21 outputs a sampling value obtained by sampling a received signal generated by the light receiving section 15 (refer to FIG. 1) for each radiation area. The distance calculation section 22 is a component functionally representing a process for calculating a distance, performed by a microcomputer 20. Note that, as is known, when the AD converter 21 receives a received signal having light receiving intensity lower than predetermined intensity, the signal received by the AD converter 21 becomes undetectable (the AD converter 21 outputs the minimum value that can be detected by the AD converter 21). Hereinafter, such a predetermined value is referred to as detection limit intensity.

The distance calculation section 22 calculates the distance between an object (detecting point) that has reflected laser light and the own vehicle by using a known method, such as a method using TOF (Time of flight), and based on a received signal waveform represented by a plurality of sampling values obtained by sampling performed by the AD converter 21, to output the calculation result to the vehicle control section 30. Note that TOF is a time period calculated based on the time period between the time when the irradiation section 14 transmits laser light and the time when the laser light reflected from the object is received by the light receiving section 15.

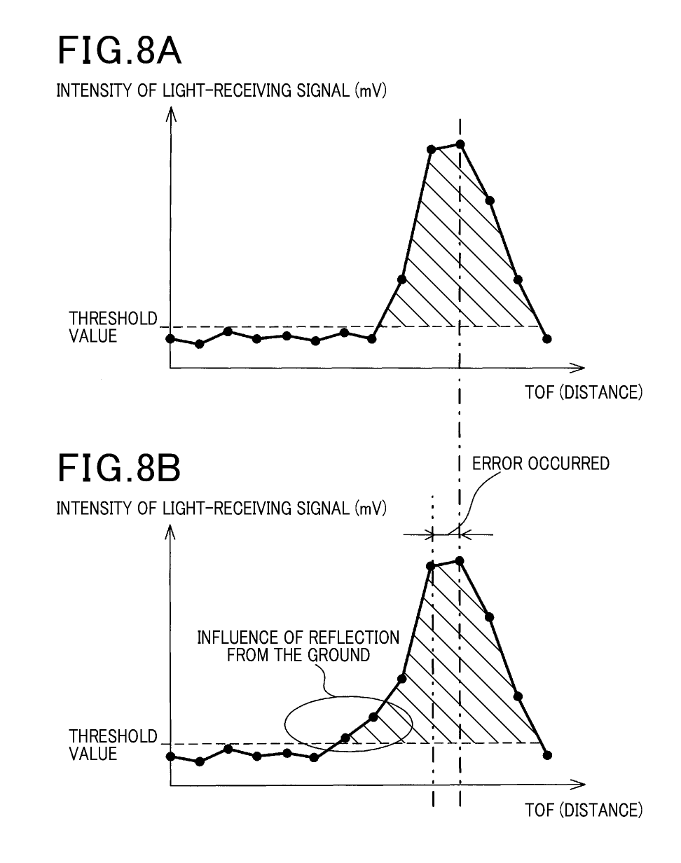

Note that, as an example, in the present embodiment, as shown in FIG. 8A described later, the center of gravity of a received signal waveform (shaded area in FIG. 8A) represented by sampling values equal to or more than a predetermined threshold value is calculated, the sampling values being included in a plurality of sampling values obtained by sampling performed by the AD converter 21. Then, the TOF corresponding to the center of gravity is specified to calculate a distance based on the specified TOF.

[Configuration of Irradiation Section]

The following experiment was performed by using an experimental optical unit similar to the optical unit 13. In the experiment, the irradiation section (14) transmits laser light to a side surface of a passenger vehicle subject to the experiment (hereinafter, referred to as experimental object), which is present separated from the experimental optical unit (13) by a distance of about 10 m. The light receiving section (15) receives the reflected light. Then, the intensity of a light-receiving signal generated by the light receiving section (15) is measured.

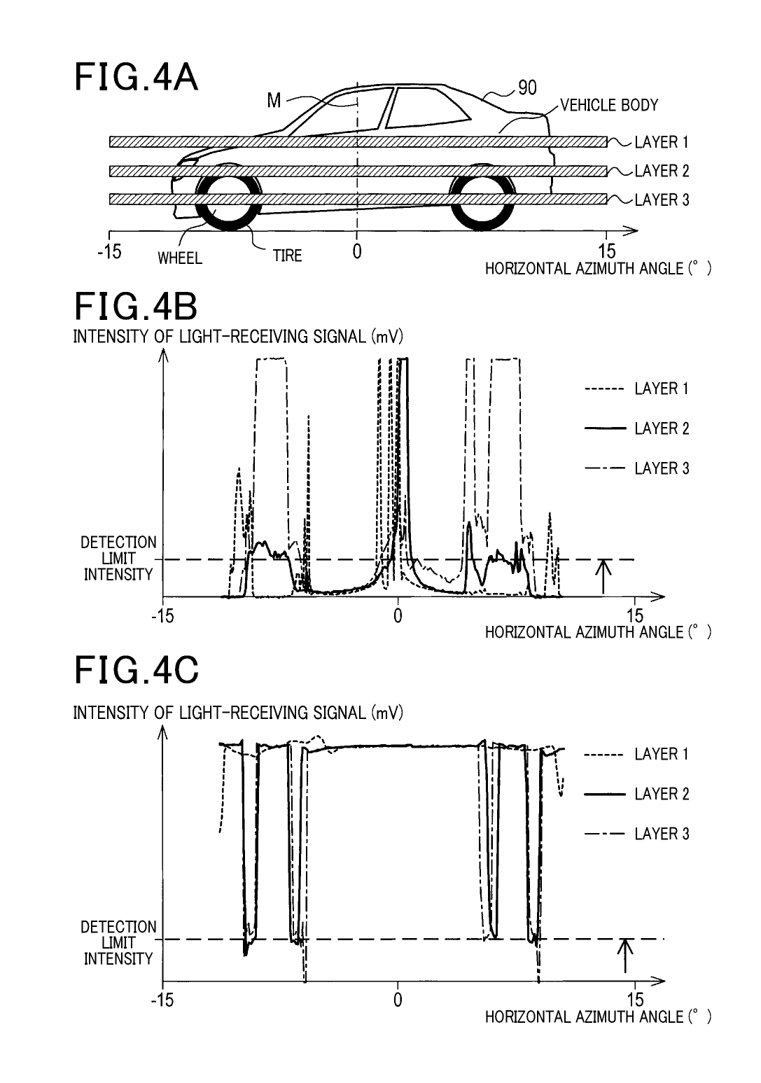

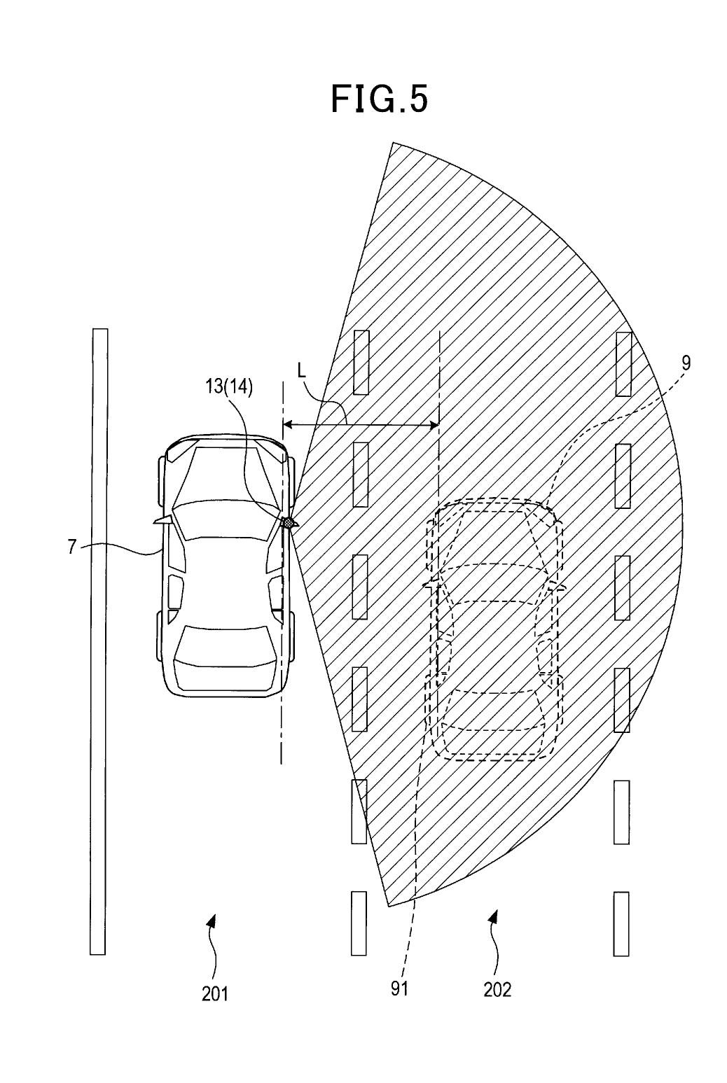

As an example, as shown in FIG. 4A, the experimental optical unit (13) is provided so that the central axis, which is an axis serving as the center of an irradiation region of the irradiation section (14) in the horizontal direction, is directed in the direction in which a center line M of the side surface of an experimental object 90 in the longitudinal direction is positioned. Note that the result of the experiment is shown by using azimuth angles (horizontal azimuth angles) centering on the center line instead of the direction numbers in the horizontal direction.

In addition, as an example, as shown in FIG. 4A, in the experimental optical unit (13), the first layer and the second layer are set so that the irradiation section (14) transmits laser light to a vehicle body of the experimental object 90, the first layer and the second layer being included in the region (refer to FIG. 2) to which the irradiation section (14) transmits laser light in the vertical direction. In addition, the third layer is set so that the irradiation section (14) transmits laser light to a wheel (or a hub cap covering the wheel) provided to a tire of the experimental object 90.

FIG. 4B illustrates a result of an experiment in which a black passenger vehicle is the experimental object 90. FIG. 4C illustrates a result of the experiment in which a white passenger vehicle is the experimental object 90.

When the experimental object 90 is a black passenger vehicle (refer to FIG. 4C), in the first layer and the second layer, light-receiving signals are detected at low light receiving intensity close to the detection limit intensity described above and within almost all the region in the horizontal azimuth except part of a specular reflection part. It can be considered that this is because, since the vehicle body is black, most of the laser light transmitted from the irradiation section 14 is absorbed by the vehicle body. However, in the third layer, a light-receiving signal is detected at high light receiving intensity higher than the detection limit intensity. It can be considered that this is because most of the laser light transmitted from the irradiation section 14 is reflected from a wheel (hub cap).

In contrast, when the experimental object 90 is a white passenger vehicle (refer to FIG. 4C), in all the first to third layers, light-receiving signals are detected at high light receiving intensity higher than the detection limit intensity. Note that it can be considered that, in the first layer and the second layer, the region detected at low light receiving intensity lower than the detection limit intensity corresponds to a region where a rubber portion (black) of a tire is present.

The fact that a reflected wave from an object is detected by the light receiving section 15 at high light receiving intensity higher than the detection limit intensity means, in other words, that the object having reflected the laser light is accurately detected by the detection section 16.

Thus, the irradiation section 14 of the optical unit 13 results in being configured so as to satisfy the following conditions (1) to (3) so that laser light transmitted from the irradiation section 14 of the radar unit 10 in the driving assistance apparatus 1 is reflected from an object, and the reflected light is detected by the light receiving section 15 at light receiving intensity higher than the detection limit intensity.

(1) The irradiation section 14 transmits light to the wheel region of an adjacent vehicle.

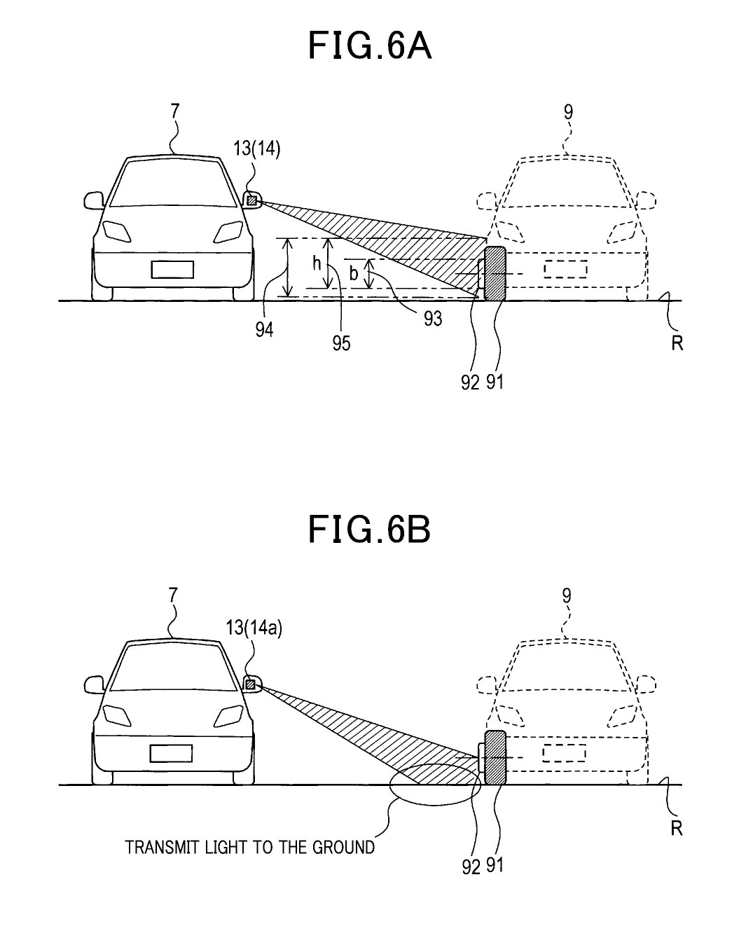

The adjacent vehicle is, as shown in FIG. 5 as an example, a vehicle (adjacent vehicle) 9 that is assumed to be present in an adjacent lane 202 adjacent to a lane (referred to as own lane) in which an own vehicle 7 runs. In addition, a wheel region 93 is, as shown in FIG. 6A as an example, a predetermined region (wheel region) in which a wheel 92 in the tire 91 of the adjacent vehicle 9 is present.

(2) The irradiation section 14 transmits light to a region assumed to be the outside of the wheel region 93 of the adjacent vehicle 9.

The region assumed to be the outside of the wheel region 93 is a region obtained by removing the wheel region 93 from the whole region 94 assumed to be a region of the side surface of the adjacent vehicle 9 at the own vehicle 7 side to which light is transmitted from the optical unit 13 (irradiation section 14).

(3) The irradiation section 14 transmits light to a position higher than the position where it is assumed that the tire 91 of the adjacent vehicle 9 contacts a road surface.

Transmitting light to a position higher than the position where it is assumed that the tire 91 of the adjacent vehicle 9 contacts a road surface means that, as shown in FIG. 6B as an example, the lower end of the irradiation region of laser light is located above the position where it is assumed that the tire 91 of the adjacent vehicle 9 contacts a road surface R so that the road surface R is not included in the irradiation region of the laser light transmitted from the irradiation section 14.

Specifically, in the present embodiment, a region higher than the lower end of the wheel 92 included in the whole region 94 of the adjacent vehicle 9 is referred to as a body irradiation region 95. In addition, the irradiation section 14 is configured to transmit laser light so that a value obtained by dividing the length b of the wheel region 93 in the vertical direction by the length h of the body irradiation region 95 in the vertical direction is a predetermined threshold value S or more.

(Expression 1)

b/h≦S (1)

In the present embodiment, the threshold value S is set to 0.1 when the lateral distance L is 3 (m) which is between a side surface of the own vehicle 7, to which the irradiation section 14 (optical unit 13) is provided, at the adjacent vehicle 9 side and a side surface of the adjacent vehicle 9 at the own vehicle 7 side. The lateral distance L is simply referred to as a distance L between the own vehicle 7 and the adjacent vehicle 9. The value of 3 (m) indicates a lateral distance assumed when the own vehicle 7 runs in the middle of an own lane 201, and the adjacent vehicle 9 runs in the middle of an adjacent lane 202.

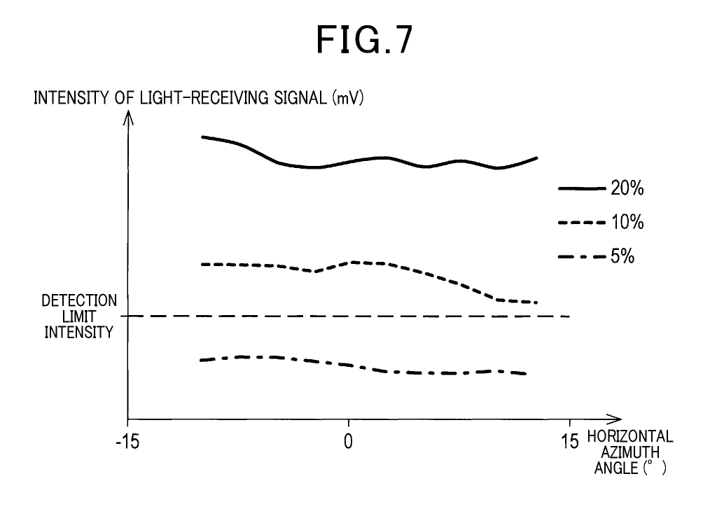

In the present embodiment, as shown in FIG. 7 as an example, it is confirmed that when the threshold value S is 0.1 or more, the reflected light from an object is detected in the horizontal direction of the adjacent vehicle 9 by the light receiving section 15 at light receiving intensity higher than the detection limit intensity.

Note that the lateral distance L may be set to any value different from 3 (m) depending on the width of the road on which the own vehicle 7 runs. In addition, the threshold value S may be set to any value different from 0.1 depending on the lateral distance L set according to the width of the road on which the own vehicle 7 runs.

In the present embodiment, the irradiation region of the third layer included in the irradiation region of the irradiation section 14 is set so as to satisfy the above conditions (1) to (3) and the expression (1). However, at least one of the first to third layers may be set so as to satisfy the above conditions (1) to (3) and the expression (1).

### Advantageous Effects

According to the first embodiment described above, the following advantageous effects can be provided.

(1A) The irradiation section 14 transmits light to the wheel region 93. Hence, a light-receiving signal having intensity higher than the detection limit intensity can be obtained from the wheel region 93. That is, even if the vehicle body is black, the vehicle can be detected based on the light reflected from a wheel having high light reflectance. Hence, regardless of the color of the vehicle, the vehicle in the adjacent lane can be detected.

(1B) The irradiation section 14 transmits light also to a region assumed to be the outside of the wheel region 93 of the adjacent vehicle 9. Thus, since the light is transmitted to a wide region including the wheel region 93, even when the adjacent vehicle 9 is positioned outside the assumed region, the reflected light is easily received from the wheel region 93. The meaning of the wording “the adjacent vehicle 9 is positioned outside the assumed region” suggests, for example, a case where the lateral distance L is shorter or longer than 3 (m), which is an assumed value.

That is, when the light is transmitted also to the region which is assumed to be outside the wheel region 93 and above the wheel region 93, even when the lateral distance L is longer than the assumed value, the reflected light can be easily received from the wheel region 93. In addition, when the light is transmitted also to the region, which is assumed to be outside the wheel region 93 and below the wheel region 93, even when the lateral distance L is shorter than the assumed value, the reflected light can be easily received from the wheel region 93.

(1C) The irradiation section 14 transmits light to a position higher than the position where it is assumed that the tire 91 of the adjacent vehicle 9 contacts the road surface R. Hence, the influence of reflection from the road surface R can be suppressed.

Hereinafter, calculation of a distance based on TOF is described as a comparative example. The calculation is performed when an irradiation section (optical unit), not shown, transmits light to a region including a position where it is assumed that the tire 91 of the adjacent vehicle 9 contacts the road surface R. In this case, as shown in FIG. 8B as an example, due to the influence of the reflected wave from the road surface R, the center of gravity of a received signal waveform (shaded area in FIG. 8B) represented by sampling values equal to or more than the threshold value differs from that of a received signal waveform (shaded area in FIG. 8A) obtained when influence of the reflection from the road surface R can be suppressed. That is, an error is caused in TOF, and therefore, in the distance.

However, according to the present embodiment, since the influence of the reflection from the road surface R can be suppressed as described above, the distance to an object can be accurately detected.

(1D) As described above, the detection section 16 is configured to detect the distance to the object based on the reflected light reflected from the object to which the light is transmitted from the irradiation section 14. Hence, based on the distance to the detected object, the driving assistance apparatus 1 can perform wide-range control regarding driving assistance of the vehicle.

Note that, in the first embodiment, the radar unit 10 corresponds to one example of an object detection apparatus.

### Second Embodiment

[Differences from the First Embodiment]

In the second embodiment, since the basic configuration is similar to that of the first embodiment, descriptions of common parts are omitted, and differences are mainly described.

In the first embodiment described above, the direction of the optical axis of laser light transmitted from the irradiation section 14 (hereinafter, referred to as irradiation section 14a) of the optical unit 13 is optional. In contrast, the second embodiment differs from the first embodiment in that the irradiation section 14 is provided to at least one of a right side portion and a left side portion with respect to the travelling direction of the own vehicle 7 so that the optical axis of laser light transmitted from the irradiation section 14 becomes parallel to or substantially parallel to the horizontal plane. The left side portion can be seen from another vehicle. The side portion is a portion of the own vehicle 7 that can be seen when the own vehicle 7 is seen laterally.

Note that, herein, a substantially parallel state is within a range of error with respect to the parallel state, though not completely parallel. According to the substantially parallel state, advantageous effects substantially similar to those of the parallel state can be obtained.

[Configuration of Irradiation Section]

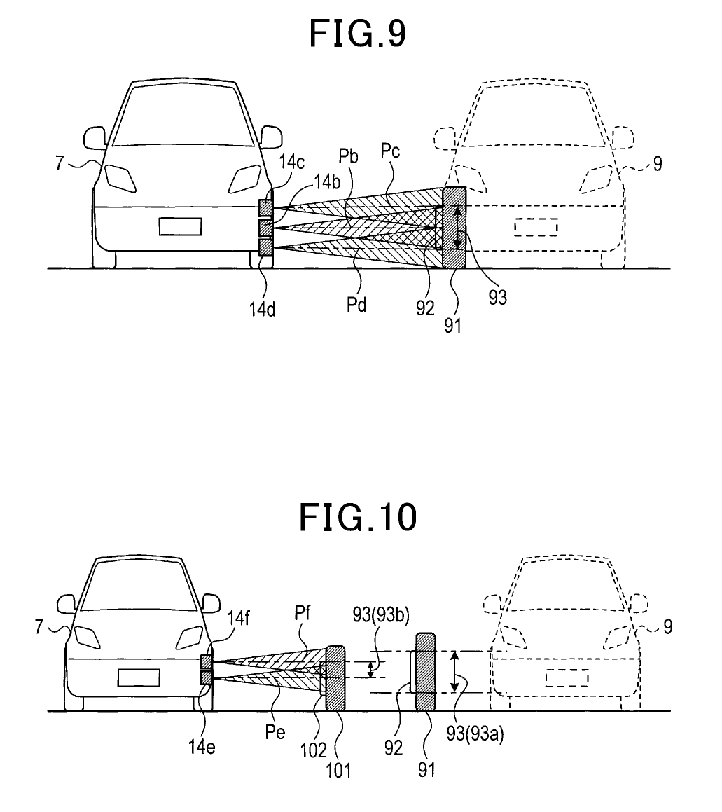

In the present embodiment, as an example, the irradiation section 14 (14a) is provided in the vicinity of the center of the right side portion of the own vehicle 7 and, as shown in FIG. 9, at a height of the center of a wheel of a tire provided to the own vehicle 7. As an example, in the present embodiment, the own vehicle 7 is an ordinary vehicle.

In addition, the optical axis P (Pb) of laser light transmitted from the irradiation section 14 (14b) is parallel to or substantially parallel to the horizontal plane.

Hence, the laser light from the irradiation section 14 (irradiation section 14b) is transmitted to the wheel region 93. Note that, in the present embodiment, the adjacent vehicle 9 is assumed to be an ordinary vehicle.

The irradiation sections 14 (14c, 14d) may be provided to the side portion of the own vehicle 7 and at heights of the upper end of a wheel of a tire provided to the own vehicle 7 (irradiation section 14c) and at a height of the lower end of the wheel (irradiation section 14d). In addition, the optical axes P (Pc, Pd) of laser light transmitted from the irradiation sections 14 (14c, 14d) may be parallel to or substantially parallel to the horizontal plane.

Note that the irradiation section 14 may be provided to at least one of the right side portion and the left side portion of the own vehicle 7.

### Advantageous Effects

According to the second embodiment described above, the following advantageous effects can be provided in addition to the advantageous effects (1A) of the first embodiment described above.

(2A) The irradiation sections 14 (14b to 14d) are provided to a side portion of the own vehicle 7 so that the optical axes P (Pb to Pd) are parallel to or substantially parallel to the horizontal plane and are positioned between the lower end and the upper end of the wheel region 93.

Accordingly, since the reflected light from the hub cap can be obtained in a state where the irradiation section 14 faces to the hub cap, the laser light from the irradiation section 14 can be suppressed from being transmitted to the ground. Hence, accuracy in detecting the distance to an object can be improved.

[First Modification]

In the above embodiment, the position where the irradiation section 14 is provided is determined assuming that the adjacent vehicle 9 is an ordinary vehicle. However, the position may be determined assuming that the adjacent vehicle 9 is a light vehicle.

That is, as shown in FIG. 10 as an example, assuming that the adjacent vehicle 9 is a light vehicle, the irradiation sections 14 (14e to 14f) may be provided so that the optical axes P are positioned within a region (hereinafter, referred to as a wheel region 93b) in which a portion between the lower end and the upper end of a wheel 102 provided to a tire 101 of the adjacent vehicle 9 is assumed to be present.

In the present modification, as shown in FIG. 10, the irradiation section 14 (14e) is provided in the vicinity of the center of the right side portion of the own vehicle 7 and at a height of the center of a wheel of a tire provided to the light vehicle.

In addition, the optical axis Pe of laser light transmitted from the irradiation section 14 (14e) is parallel to or substantially parallel to the horizontal plane as in the case of the second embodiment.

Thus, since the wheel region 93 (hereinafter, 93a) of an ordinary vehicle is wider than the wheel region 93b of a light vehicle, laser light from the irradiation sections 14 (14e to 14f) can be reliably transmitted to the wheel region 93a of the ordinary vehicle. Hence, accuracy in detecting the light vehicle and accuracy in detecting the ordinary vehicle can be improved.

Note that the irradiation section 14 may be provided to a side portion of the own vehicle 7 and within a range of height at which a wheel of a tire provided to the light vehicle is positioned.

[Second Modification]

In the above embodiments, the position where the irradiation section 14 is provided is determined so that the optical axis of the transmitted laser light is positioned within the wheel region 93 in which a portion between the lower end and the upper end of the wheel 92 of the adjacent vehicle 9 is assumed to be present. However, the position where the irradiation section 14 is provided may be determined so that the optical axis of the transmitted laser light is positioned within a region in which a portion between the center and the upper end of the wheel 92 of the adjacent vehicle 9 is assumed to be present (between the center and the upper end of the wheel region 93).

Specifically, in the present modification, as shown in FIG. 10 as an example, assuming that the adjacent vehicle 9 is a light vehicle, the irradiation section 14 (14f) is provided in the vicinity of the center of the right side portion of the own vehicle 7 and at a height of the upper end of a wheel of a tire provided to the light vehicle. Note that the irradiation section 14 may be provided at any height within a range of height at which a portion between the center and the upper end of a wheel of a tire provided to the light vehicle is positioned. Alternatively, the irradiation section 14 may be provided at any height within a range of height at which a portion between the center and the upper end of a wheel of a tire provided to the ordinary vehicle is positioned.

In addition, the optical axis Pf of laser light transmitted from the irradiation section 14 (14f) is parallel to or substantially parallel to the horizontal plane as in the case of the second embodiment.

Hence, since the laser light from the irradiation section 14 (14f) is further suppressed from being transmitted to the ground, accuracy in detecting the distance to an object can be improved.

It will be appreciated that the present invention is not limited to the configurations described above, but any and all modifications, variations or equivalents, which may occur to those who are skilled in the art, should be considered to fall within the scope of the present invention.

### Other Embodiments

(3A) In the above embodiment, the irradiation section 14 is configured to transmit laser light to the region (wheel region 93) in which a wheel of a tire of the adjacent vehicle 9 is assumed to be positioned. However, when the tire of the adjacent vehicle 9 is provided with a hub cap, the irradiation section 14 may transmit laser light to the region in which the hub cap of the tire of the adjacent vehicle 9 is assumed to be positioned.

(3B) In the above embodiment, in the driving assistance apparatus 1, the irradiation section 14 (optical unit 13) of the radar unit 10 is provided to the right side portion of the own vehicle 7, and detects a vehicle in the adjacent lane 202 at the right of the own vehicle 7. However, for example, the irradiation section 14 (optical unit 13) of the radar unit 10 may be provided to the left side portion of the own vehicle 7, and may detect a vehicle in the adjacent lane at the left of the own vehicle 7. The driving assistance apparatus 1 may be provided with the radar units 10 (irradiation sections 14) at both of the right side portion and the left side portion of the own vehicle 7.

(3C) A function of one component in the embodiments may be separated into a plurality of components. Alternatively, functions of a plurality of components may be integrated into one component. Part of the configurations of the embodiments may be omitted. In addition, at least part of the configuration of an embodiment may be added to the configuration of another embodiment, or may be replaced with the configuration of another embodiment.

Hereinafter, aspects of the above-described embodiments will be summarized.

As an aspect of the embodiment, an object detection apparatus includes an irradiation section (14) and a detection section (16). The irradiation section transmits light. The detection section detects an object that has reflected light transmitted from the irradiation section, based on reflected light reflected from the object to which the light is transmitted from the irradiation section. In addition, the irradiation section transmits the light to a wheel region of an adjacent vehicle. The adjacent vehicle is assumed to be present in an adjacent lane adjacent to a lane in which an own vehicle runs. The wheel region is a predetermined region in which a wheel of the adjacent vehicle is assumed to be present.

According to the above configuration, when an adjacent vehicle is present, the adjacent vehicle is detected based on the light reflected from a wheel of the adjacent vehicle. That is, even if the vehicle body is black, the vehicle can be detected based on the light reflected from the wheel having high light reflectance. Hence, without depending on the color of the vehicle body of the adjacent vehicle, the vehicle can be detected.

What is claimed is:

1. An object detection apparatus, comprising:
an irradiation section that transmits light; and
a detection section that detects an object that has reflected light transmitted from the irradiation section, based on reflected light reflected from the object to which the light is transmitted from the irradiation section, wherein
the irradiation section transmits the light to a wheel region of an adjacent vehicle, the adjacent vehicle being assumed to be present in an adjacent lane adjacent to a lane in which an own vehicle runs, the wheel region being a predetermined region in which a wheel of the adjacent vehicle is assumed to be present.

2. The object detection apparatus according to claim 1, wherein
the irradiation section transmits light to a region assumed to be outside of the wheel region of the adjacent vehicle.

3. The object detection apparatus according to claim 1, wherein
the irradiation section transmits light to a position higher than a position where it is assumed that a tire of the adjacent vehicle contacts a road surface.

4. The object detection apparatus according to claim 1, wherein
the irradiation section is provided to at least one of a right side portion and a left side portion with respect to a travelling direction of the own vehicle so that an optical axis of the light transmitted from the irradiation section becomes parallel to or substantially parallel to a horizontal plane.

5. The object detection apparatus according to claim 4, wherein
assuming that the adjacent vehicle is a light vehicle, the irradiation section is provided so that the optical axis of the irradiation section is positioned within a region in which a portion between a lower end and an upper end of the wheel of the adjacent vehicle is assumed to be present.

6. The object detection apparatus according to claim 1, wherein
the detection section detects a distance to the object based on the reflected light.
